(19) United States
(12) Patent Application Publication
(10) Pub. No.: US 2025/0386763 A1
(43) Pub. Date: Dec. 25, 2025

(54) LAWNMOWER WITH CUT QUALITY IMPROVEMENT FEATURES

(71) Applicant: Milwaukee Electric Tool Corporation, Brookfield, WI (US)

(72) Inventors: Bryan Edler, Brookfield, WI (US); Mark C. Hughes, Brookfield, WI (US); Michael Steven Van Dyke, Wauwatosa, WI (US); Beth E. Cholst, Wauwatosa, WI (US); Casey Garces, Brookfield, WI (US)

(21) Appl. No.: 19/239,410

(22) Filed: Jun. 16, 2025

Related U.S. Application Data
(60) Provisional application No. 63/662,038, filed on Jun. 20, 2024.

(51) Int. Cl. A01D 34/73; A01D 34/00; A01D 34/68; A01D 34/78; A01D 42/04; A01D 43/02; A01D 43/077; A01D 101/00

(52) U.S. Cl. CPC A01D 34/73; A01D 34/003; A01D 34/6806; A01D 42/04; A01D 43/02; A01D 43/077; A01D 34/78; A01D 2101/00

(57) ABSTRACT

A lawnmower including: a mower deck defining a volume; a driving element configured to drive a cutting implement within the volume; a plurality of wheels supporting the mower deck; and a handle extending in a rearward direction from the mower deck, wherein the mower deck defines a first radial length A₁, as measured from a central vertex of the cutting implement to a front lip of the mower deck, and a second radial length A₂, as measured from the central vertex to a lateral lip of the mower deck, wherein an aspect ratio of the first and second radial lengths [A₁/A₂] is at least 1.05, and wherein a tip distance, as measured between the front lip of the mower deck and a nearest part of the cutting implement when the cutting implement extends in a forward-rearward direction, is at least 1.5 inches.

### CROSS-REFERENCE TO RELATED APPLICATIONS

The present application claims priority to U.S. Provisional Patent Application Ser. No. 63/662,038, filed on Jun. 20, 2024, the disclosure of which is incorporated by reference herein in its entirety.

### FIELD

The present disclosure relates generally to outdoor power tools, such as lawnmowers, that exhibit improved cut quality and better manage clipping.

### BACKGROUND

Outdoor power tools, such as lawnmowers, utilize a rotating blade assembly with cutting one or more cutting blades to cut into material, such as grass. The cutting blades are rotatably driven by a driving element (e.g., a motor) along a central axis in a continuous manner. The driving element may, for example, be controlled by a trigger or bail located on a handle of the lawnmower. As the operator engages the trigger or bail, the driving element may be activated, resulting in operation of the lawnmower.

Recently, battery powered outdoor power tools have increased in popularity. Such outdoor power tools have had issues with cut quality and clumping. For example, protective features of the lawnmower may cause grass to lay down before being cut by the blades. As a result, the quality of cut is reduced. Additionally, grass clippings are likely to become stuck inside of the body of the protective features or are not sufficiently dispersed upon exit.

Accordingly, improvements which address the above-described issues are desired in the art and would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a lawnmower is provided. The lawnmower includes a mower deck defining a volume; a driving element configured to drive a cutting implement within the volume; a plurality of wheels supporting the mower deck; and a handle extending in a rearward direction from the mower deck, wherein the mower deck defines a first radial length A₁, as measured from a central vertex of the cutting implement to a front lip of the mower deck, and a second radial length A₂, as measured from the central vertex to a lateral lip of the mower deck, wherein an aspect ratio of the first and second radial lengths [A₁/A₂] is at least 1.05, and wherein a tip distance, as measured between the front lip of the mower deck and a nearest part of the cutting implement when the cutting implement extends in a forward-rearward direction, is at least 1.5 inches.

In accordance with another embodiment, a mower deck for a lawnmower is provided. The mower deck includes a body defining a volume having a first radial length A₁, as measured from a central vertex of a cutting implement housed in the mower deck to a front lip of the mower deck, and a second radial length A₂, as measured from the central vertex to a lateral lip of the mower deck, wherein an aspect ratio of the first and second radial lengths [A₁/A₂] is at least 1.05, and wherein a tip distance, as measured between the front lip of the mower deck and a nearest part of a cutting implement to be received in the mower deck when the cutting implement extends in a forward-rearward direction, is at least 1.5 inches.

In accordance with another embodiment, a method of mowing is provided. The method includes activating a bail and a throttle to propel the lawnmower while a cutting implement is driven to rotate within a volume of a mower deck; as the lawnmower moves forward, causing, by a front lip of the mower deck, grass blades to become bent under the front lip to form a no-cut zone within the mower deck; and as a result of a tip distance, as measured between the front lip of the mower deck and a nearest part of the cutting implement when the cutting implement extends in a forward-rearward direction, being at least 1.5 inches, the grass blades entering a cut zone of the cutting implement within 25% of the nearest part of the cutting implement when the cutting implement extends in the forward-rearward direction.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a lawnmower in accordance with embodiments of the present disclosure;

FIG. 2A is a bottom view of a lawnmower including a circular shaped mower deck in accordance with embodiments of the present disclosure;

FIG. 2B is a bottom view of a lawnmower including a forward extended mower deck in accordance with embodiments of the present disclosure;

FIG. 3 is a schematic view of various shapes associated with different mower decks in accordance with embodiments of the present disclosure;

FIG. 4 is a bottom view of a lawnmower in accordance with embodiments of the present disclosure;

FIG. 5 is a cross-sectional side view of a mower deck and cutting implement contained within a volume of the mower deck in accordance with embodiments of the present disclosure;

FIG. 6 is a cross-sectional front view of a lawnmower in accordance with embodiments of the present disclosure;

FIG. 7 is a front view of a rake attached to a lawnmower in accordance with embodiments of the present disclosure;

FIG. 8 is a side view of a rake attached to a lawnmower in accordance with embodiments of the present disclosure;

FIG. 9 is a cross-sectional side view of a lawnmower including a diffuser in accordance with embodiments of the present disclosure;

FIG. 10 is a bottom view of a portion of a lawnmower including a diffuser in accordance with embodiments of the present disclosure;

FIG. 11 is a perspective view of a diffuser in accordance with embodiments of the present disclosure;

FIG. 12 is a bottom view of a lawnmower including rear rakes in accordance with embodiments of the present disclosure;

FIG. 13 is a bottom view of a rear rake in accordance with embodiments of the present disclosure;

FIG. 14 is a lateral side view of a rear rake in accordance with embodiments of the present disclosure;

FIG. 15 is a perspective view of a rear rake in accordance with embodiments of the present disclosure;

FIG. 16 is plot of wheel pack encountered by a lawnmower using a rear rake and a control in accordance with embodiments of the present disclosure;

FIG. 17 is a rear perspective view of a lawnmower including a trailing conditioner in accordance with embodiments of the present disclosure;

FIG. 18 is a plot of weighted score of a lawnmower using a trailing condition and a control in accordance with embodiments of the present disclosure;

FIG. 19 is an angled view of a bottom of a lawnmower including an agitator assembly in accordance with embodiments of the present disclosure;

FIG. 20 is an agitator in accordance with embodiments of the present disclosure; and

FIG. 21 is a top view of a portion of a cutting implement in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising.” “includes,” “including.” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

The term mower deck is used herein with reference to a housing that extends over and at least partially around a volume in which a cutting implement, such as a blade, is operated. As used herein with respect to the mower deck, the term “extended” refers to an enlarged dimensional aspect as compared to a traditional circular shape. A mower deck having an extending front end thus is enlarged in a forward direction. The forward direction relates to a direction of travel when the mower is actively mowing (independent of when the mower is moving in reverse, i.e., opposite the forward direction).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Traditional lawnmowers have generally circular-shaped mower decks. This circular shape allows the rotating cutting implement housed within the mower deck to remain within a constant, or substantially constant, distance from the mower deck lip. It was believed that such constant, or substantially constant, distance improved mowing performance.

In general, lawnmowers in accordance with embodiments described herein exhibit overall improved cutting performance, improved grass aesthetic, and/or improved management of grass clippings, particularly when a clipping bag is not attached to the lawnmower and the clippings are deposited (left) on the underlying ground surface.

The lawnmower can include a mower deck having an elongated dimension. The elongated mower deck can be elongated in a forward (front) direction while remaining within a traditional (circular) boundary at lateral ends, the rear end, or both the lateral ends and the rear end. In some implementations, the entire front half (i.e., the forwardmost 50% of the perimeter of the mower deck) is elongated, e.g., stretched forward. In other implementations, only a portion of the front half of the mower deck is elongated. For example, only a forwardmost 25% or 33% of the perimeter of the mower deck may be elongated. In yet other implementations, the front and rear halves of the mower deck may both be elongated in the forward-rearward direction.

In an embodiment, the elongated mower deck lip (i.e., the lowermost edge of the mower deck) can define a generally smooth edge around the entire perimeter of the mower deck. While the radius of curvature may vary about the perimeter, transition points between different radii of curvature may be smooth. In another embodiment, the mower deck can define an abruptly elongated forward elongation. For example, the front lip may be substantially more planar (i.e., lie significantly closer to a plane) than the remainder of the mower deck lip, or even be planar (i.e., rest along a plane). The substantially more planar or planar front lip can meet lateral aspects of the mower deck at curved transitions, angled transitions, filleted junctions, or the like.

The lawnmower includes a cutting implement that is driven within the mower deck to perform a cutting operation. The cutting implement, typically a blade, traditionally operates at a fixed length. The blade is driven to rotate within the mower deck and defines a constant radius about an entire rotational cycle. A tip distance between a tip of the blade and the lip varies in accordance with embodiments described herein. More particularly, the tip distance is greater in the forward-rearward direction (at least when the blade is in the forward half of the mower deck) than the lateral direction.

As the front lip of the mower deck traverses an underlying ground surface, grass encountered by the front lip of the mower deck is bent under the force of the lip of the mower deck passing thereover. This bending is typically in the direction of travel (i.e., the grass bends forward as the lawnmower passes thereover). As a result, the grass enters the mower deck in a bent state, as pinned down by the front lip. Not until the front lip is clear of the individual blades of grass, do the grass blades substantially begin to return to their original, upright state. Even then, some of the freed grass blades may remain partially held down by other grass blades currently pinned down by the front lip. While the cutting implement may reach the grass blades prior to their return to their original, upright state (i.e., when the grass blades are semi-bent), some bend remains in the grass blades upon first impact with the cutting implement. The longer it takes for the grass blades to return to the original, upright state (or even the semi-bent state) the deeper into the mower deck the grass blades travel prior to first cut and the less number of times the grass blades are subjected to cutting.

The forward elongated mower deck lip advances return of the grass blades to the unbent state sooner with respect to the cutting implement. That is, by elongating the front lip of the mower deck X units of distance in the forward direction, the grass blades become unpinned from the lip of the mower deck sooner relative to passage by the cutting implement and can begin to return to their original, upright position X units of distance further in advance of the cutting implement, thus exposing the grass to the cutting implement sooner and increasing the number of passes the cutting implement actually strikes the blade of grass.

Lawnmowers described herein can further include features and components to improve grass clipping management, i.e., grass clippings which are cut by the cutting implement and deposited onto the underlying grass surface.

For example, the lawnmower can include a rake disposed in front of the mower deck. The rake can precondition the grass blades prior to entering the mower deck. Preconditioning can include, for example, grass uplift (stand-up effect) which helps the grass more fully rise prior to being cut, debris displacement which moves debris away from the cutting deck or breaks up the debris, clump separation which prevents motor bogging, airflow conditioning to enhance the vacuum effect created by the moving cutting implement, thatch agitation, etc. The rake includes projections, e.g., teeth, that extend downward towards the underlying ground surface. The teeth can be arranged in a plurality of rows, such as a first row and a second row. The rows can be oriented perpendicular to the forward direction of travel. The rows can be laterally staggered such that teeth in one row do not align with teeth in a neighboring row in the forward direction.

The lawnmower can also, or alternatively, include wheel rakes. The wheel rakes can be coupled to the lawnmower in front of the lawnmower's rear wheels. The rear wheels may be driven wheels, i.e., driven by a motor to propel the lawnmower in a powered walking mode. The wheel rakes may have teeth that extend downward towards the underlying ground surface. The teeth of the wheel rakes can precondition the underlying ground surface where the wheels ride. In this regard, any clippings discharged at the lateral side of the mower deck (sometimes referred to as lawn stripes), any clumps, or the like can be moved or broken up so as to not be compacted into the ground by the rear wheels. The wheel rakes may also, or alternatively, provide for the removal of detritus from treads of the wheels. For example, the wheel rakes can be coupled in close proximity to the wheels such that as the tread moves past the wheel rake, any detritus on the tread is scraped therefrom. The wheel rakes can channel the detritus to a desirable location to further avoid compaction by the rear wheels.

In an embodiment, the lawnmower can also, or additionally, include a trailing conditioner. The trailing condition can be pulled by the lawnmower behind the mower deck. The trailing conditioner can include a sheet that drags along the underlying ground surface. The sheet can include perforations that receive grass blades to pull apart clumps using the force of the lawnmower moving relative to the underlying surface. In an embodiment, the sheet is formed from expanded metal. The ridges formed at the edges of the perforations of expanded metal may grab and hold individual blades of grass within clumps such that the clump is more easily broken up by movement of the lawnmower, i.e., the sheet.

In some implementations, the lawnmower can also, or additionally, include a diffuser. The diffuser can be coupled, e.g., removably coupled, to the lawnmower at a rear end of the mower deck. In some implementations, the diffuser may be coupled to the lawnmower in a similar manner as a clippings bag. The diffuser can receive clippings from the mower deck and distribute the clippings in a diffusion pattern along the underlying ground surface. The diffusion pattern may be shaped to a desired discharge pattern. For example, the diffusion pattern may resemble a gaussian distribution (i.e., a symmetrical bell-shaped curve), a linear skewed curve left or right, a log-normal distribution skewed left or right, a uniform distribution, a binomial distribution, a multinomial distribution, or the like. Certain diffusion patterns may be particularly suitable for certain types of grass or certain cut conditions. The user may be able to switch between diffusion patterns either at the diffuser, e.g., by adjusting a portion of the diffuser, or by swapping between different diffusers. Using the diffuser, grass clippings can be directed in beneficial directions to yet further avoid clumping and unsightly lawn striping. The diffuser may be unpowered and operate to generate the diffusion pattern solely under the forces generated by movement of the cutting implement.

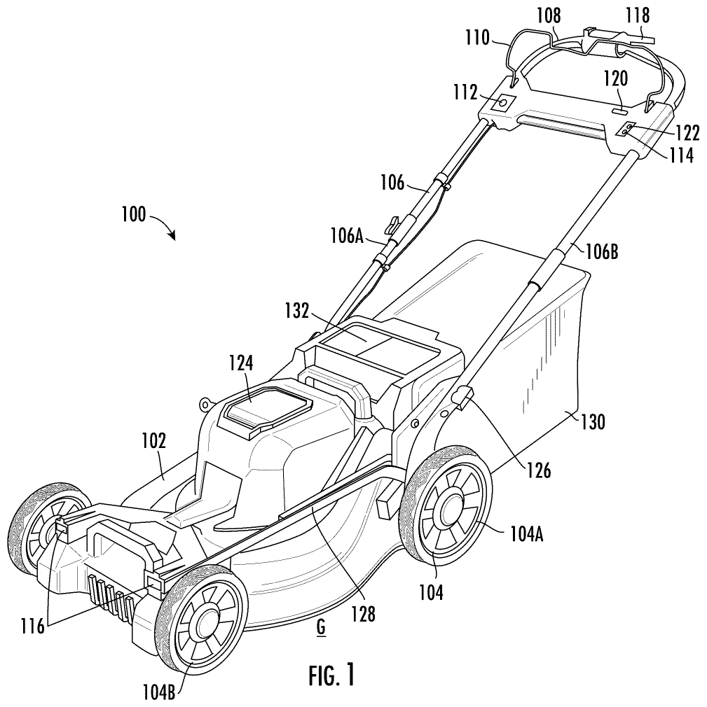

Referring now to the drawings, FIG. 1 illustrates a lawnmower 100 in accordance with an example embodiment. The lawnmower 100 generally includes a mower deck 102 supported by a plurality of wheels 104. The wheels 104 include rear wheels 104A and front wheels 104B. In an embodiment, the rear wheels 104A are driven by a driving element, such as a motor. The rear wheels 104B can interface with the driving element in an overrun configuration such that the user can overrun a speed of the lawnmower 100, such as when turning.

A handle 106 extends from a location adjacent to a rear of the mower deck 102 in a rearward direction. The handle 106 can include left and right members 106A, 106B coupled together through a user interface 108. In an embodiment, lengths of the left and right members 106A, 106B may be adjustable to allow the lawnmower 100 to be reconfigured between different sized users. The user can guide the lawnmower 100, i.e., steer the lawnmower 100, over the underlying ground surface G using the handle 106.

The handle 106 can include user implements which allow the user to manipulate a controllable aspect of the lawnmower 100. The user implements can include, for example, a bail 110, a power switch 112, an auxiliary switch 114 which can control one or more auxiliary functions (e.g., activate and deactivate lights 116), a speed controller 118 (i.e., throttle) that is adjustable to control a speed of the rear wheels 104A, an indicator 120 that notifies the user of a current operating status (e.g., a current battery charge, a remaining battery lifespan, etc.), and a blade controller 122 that allows the user to switch between two or more different blade speeds. Additional user implements can be disposed on the handle 106 to permit user adjustment of the mowing operation.

The mower deck 102 can support a battery housing 124 which receives a battery (not illustrated) that powers a driving element to drive one or more cutting implements. The driving element can be disposed at the mower deck 102, extending into a volume defined by the mower deck to engage with the cutting implement, e.g., one or more cutting blades. The driving element can include a motor (such as a direct current (DC) motor) having an output shaft that is rotatably keyed to the one or more cutting implements. The cutting implements(s) can include one blade, two blades, three blades, etc. The blades can be rotationally clocked (offset) from one another. The cutting implements may also, or alternatively, be part of separate cutting aspects, such as a left cutting implement (e.g., a left blade) and a right cutting implement (e.g., a right blade) or a front cutting implement (e.g., a front blade) and a rear cutting implement (e.g., a rear blade), each powered by a separate motor or separate powered drive shaft. The speed of the motor can be controlled from the handle 106 to affect different cut speeds. Similarly, the user may control the speed of the wheels 104A from the handle 106 using the speed controller 118.

The mower deck 102 may be adjustable between different operational heights each associated with a different height of cut. For example, the lawnmower 100 can include a deck height adjustment lever 126. The deck height adjustment lever 126 can be movable, e.g., pivotable, between two or more positions each associated with a different height of the mower deck 102. In the depicted embodiment, the deck height adjustment lever 126 is disposed adjacent one of the rear wheels 104A. However, in other instances, the deck height adjustment lever 126 can be disposed at a different location and/or include a different type of user actuatable interface (e.g., a slidable deck height adjustment mechanism). The deck height adjustment lever 126 can be coupled to the front wheels 104A through a linkage 128. As the deck height adjustment lever 126 is moved between different relative positions, the linkage 128 can affect the same, or similar, height displacement of the front wheels 104A as caused by the deck height adjustment lever 126 at the rear wheels 104B.

The mower deck 102 can define a rear opening (not illustrated) through which clippings can be discharged from the mower deck 102 during mowing operations. A bagging system, such as a bag 130, can be coupled adjacent to the rear opening of the mower deck 102 to catch clippings as they are discharged from the mower deck 102. The bag 130 may be removably coupled to the lawnmower 100 to permit the user to switch between different styles of mowing, e.g., bagging, mulching, regular discharge, or the like. A cover 132 selectively pivots from a blocking position (which covers the rear opening) to a non-blocking position to allow attachment of the bag 130.

Embodiments described herein allow for improved management of grass clippings, particularly when the bag 130 is not attached to the lawnmower 100. During non-bagged operations, i.e., when the bag 130 is not present, clippings are discharged from the mower deck 102 back to the underlying ground surface G. Based on the characteristics of the lawnmower 100, these clippings typically form a discharge pattern. For example, lawnmowers typically disperse clippings in a linear manner, creating rows of clippings across the underlying ground surface G. These rows are sometimes referred to as striping. Striping may occur as a result of the air pressure profile within the volume defined by the mower deck 102. When the air pressure profile is eccentrically skewed, e.g., to one side of the mower deck 102, the clippings tend to move in a consistently skewed direction, resulting in the buildup of elongated rows of clippings as the mower passes thereover. These rows typically occur along the left or right side of the mower deck 102. This distribution may be problematic as lateral, i.e., left and right, sides the mower deck 102 may align with the wheels 104. That is, the discharged clippings form rows directly in the path of the rear wheels 104A. As a result, the lawnmower 100, and more particularly the rear wheels 104A, then roll over the clippings, causing the clippings to compress and clump together. This is particularly problematic when the grass is wet, such as after a rain storm, after build up of morning dew, or the like. In these circumstances, the rows of clippings can be difficult to manage.

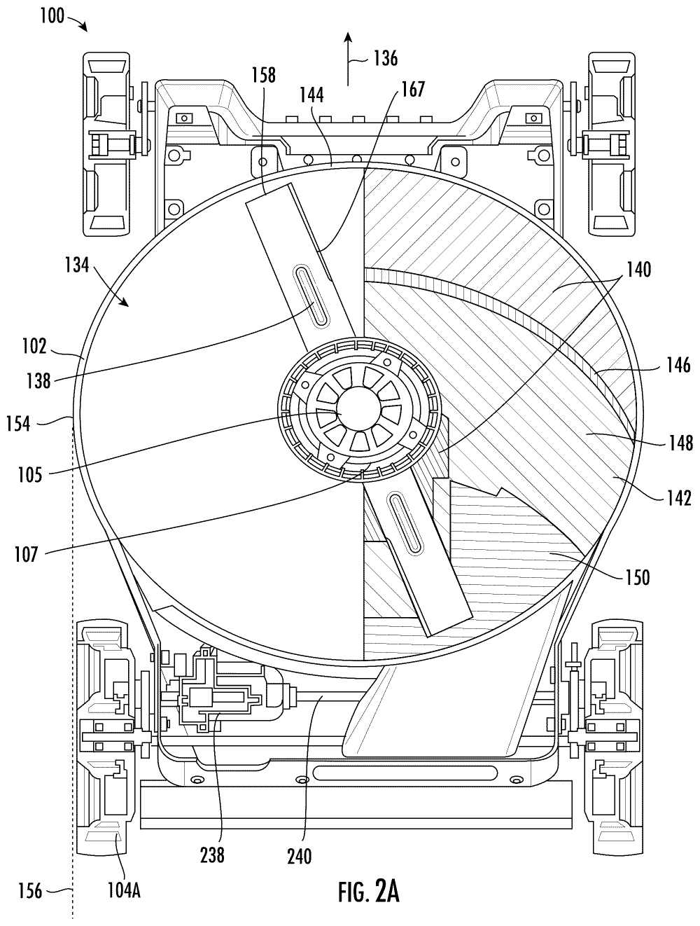

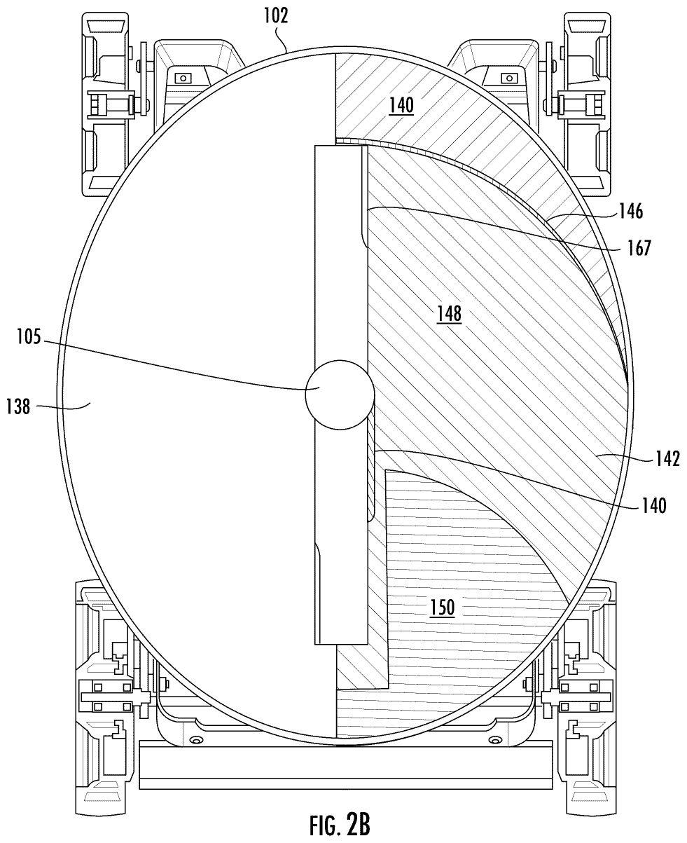

Embodiments described herein can improve cut quality. Improvement in cut quality refers to a better, more consistent cut of grass as the lawnmower 100 traverses over the underlying ground surface G, regardless of the speed of the lawnmower 100 between minimum and maximum speeds of travel. Referring to FIG. 2A, an underside of a traditional circular-shaped lawnmower 100 is depicted with a schematic representation of relative effective cutting areas within a volume 134 of the mower deck 102 as the lawnmower 100 is moved in a forward direction 136. For purpose of illustration, the representation of relative effective cutting areas is only shown with respect to half of the volume 134. It should be understood that the relative effective cutting areas of the non-illustrated half may be similar, or even the same, as the illustrated half. Alternatively, the relative effective cutting areas may be different at the other half, e.g., as a result of a different air pressure profile generated by the cutting implement, e.g., blade 138, as it rotates within the other half of the volume 134. That is, due to the nature of the blade 138 rotating in a same (constant) direction about 360 degrees of travel, some of the grass blades are cut with the blade 138 moving with the direction of travel 136 while other grass blades are cut with the blade 138 moving opposite the direction of travel 136. For purposes of simplicity, it is herein assumed that the relative effective cutting areas of both halves are generally symmetrical with respect to one another about a centerline extending in the direction of travel 136.

The relative effective cutting areas include two zones-a first zone 140 which corresponds with a no-cut zone, and a second zone 142 which corresponds with a cut zone. In the no-cut zone 140, grass is typically left uncut by the blade 138 despite the blade 138 passing thereover. Conversely, the cut zone 142 defines an area where the grass is at least partially cut by the blade 138. The no-cut zone 140 is arranged at a front end of the volume 134 where a lip 144 of the mower deck 102 impacts the grass, thereby causing the individual grass blades to bend prior to entering the volume 134. Due to the relatively slow rebound properties of grass and other underlying plants, the individual grass blades may remain at least partially bent as they pass into the volume 134. This results in the blade 138 failing to strike the grass in the no-cut zone 140. It should be understood that the depth of the no-cut zone 140 (i.e., the distance between the lip 144 and the rear edge of the no-cut zone 140) may increase as mower speed increases, however, the relative shape of the no-cut zone 140 remains relatively unaffected by speed but may elongate in the direction of travel. It is additionally noted that the no-cut zone 140 may also extend from a location behind the motor 105, i.e., where the motor 105 or an interface 107 between the motor 105 and the blade 138 occurs. The motor 105 or interface 107 thus acts similar to the mower deck 102, causing the blades of grass to bend. Reference to the no-cut zone 140 described herein is largely focused on the no-cut zone 140 defined behind the lip 144.

Within the cut zone 142, there are a plurality of different zones, each distinguished by a relative cut achieved by the blade 138. For example, the cut zone 142 can include a transition zone 146, a middle zone 148, and a peak-cut zone 150. The transition zone 146 abuts the no-cut zone 140 and defines a first zone within the volume 134 in which the grass blades begin to rise, thereby allowing the blade 138 to strike and cut the risen grass blades. Behind the transition zone 146 is the middle zone 148 in which the individual grass blades are partially cut, but may not be cut to the desired height. That is, as the grass blades start rising towards the blade 138 in the transition zone 146, the blade 138 may strike the grass at a height above the desired height of cut in the middle zone 148. This results in the generation of a first (initial) cut in the grass. As the lawnmower 100 continues to travel in the direction 136, the grass blades enter the peak-cut zone 150 in which the grass blades have substantially risen to their original height and thus cut at their final, desired height of cut. Within the peak-cut zone 150, the desired height of cut is achieved. Of course, the height of cut is actively reduced (i.e., made closer to the ground) throughout the entire portion of the cut zone 142, but final, desired height of cut is largely realized at the peak-cut zone 150.

Given the discovered placement of these relative cut- and no-cut zones 142, 140, placement of the lip 144 is herein modified from traditional placement to advance the transition zone 146 further forward, thereby advancing each of the individual cut zones 140 in the forward direction. As a result, the blade 138 is able to pass over the upright grass further forward within the mower deck, allowing for a greater number of cuts to occur, thereby achieving a better, more consistent quality of cut. Additionally, the grass is cut, at least on average, more fully upright, resulting in a greater initial cut depth and reducing the number of grass clippings generated by rotation of the blade 138.

FIG. 3 shows three example lip profiles each associated with a different mower deck. A first profile A corresponds to a lip associated with a traditional mower deck having a circular shape. A second profile B corresponds to a lip associated with a mower deck 102 elongated in a forward direction 141 and a rearward direction 143. A third profile C corresponds to a lip associated with a mower deck 102 elongated in the forward direction 141 and non-elongated in the rearward direction. In this regard, the third profile C can generally correspond to the first profile A in the rearward direction 143 and the second profile B in the forward direction 141. Mower decks associated with profile A may be referred to as traditional. Mower decks associated with profile B may be referred to as dual-extended. Mower decks associated with profile C may be referred to as forward-extended.

Traditionally, mower decks with profile A have been made circular in shape, defining a constant radius of curvature about the entire perimeter. Due to the circular arc shape of blade travel, as propelled by the driving element, it has been traditionally believed that a circular mower deck would benefit the air profile within the volume of the mower deck. Specifically, it was believed that a continuously minimal gap between blade tip and the mower deck would result in improved lawnmower performance. Benefits were believed to include improved airflow and lift as pressure within the volume of the mower deck was more uniform and the tight. Consistent clearance was believed to help maximize suction through the venturi effect, thereby causing the grass to lift before being cut. Uneven or large gaps were believed to disrupt airflow, reduce suction, and allow grass to deflect away from the blades more easily. Additionally, lawnmowers compatible with mulching blades (i.e., all lawnmowers) were believed to benefit from a tight-fitting mower deck to help suspend clippings for a longer duration of time, allowing them to be re-cut additional times. Yet further, it was traditionally believed that grass discharge from the mower deck was made more efficient and clumping was reduced by having a uniform airflow only achievable by a consistent gap between the blade tip and mower deck.

However, the use of a lip 144 that is elongated in the forward direction (e.g., profiles B and/or C) has been found to improve mowing efficiency and provide better clipping discharge with improved distribution as compared to traditional mower decks having circular, or substantially circular shapes.

The mower deck 102 defines a central vertex 152 corresponding with a central position of the blade 138. The central vertex 152 can also correspond to a central position between lateral lips of the mower deck 102. The lip 144 can define a radial length A₁ in the forward direction, as measured from the central vertex 152, and a radial length A₂ in the lateral direction, as measured from the central vertex 152. The radial lengths A₁ and A₂ are angularly displaced from one another by 90 degrees about the central vertex 152. For profile A, A₁ is equal, or approximately equal, to A₂. For profiles B and C, A₁ is larger than A₂. For example, an aspect ratio of A₁ and A₂ [A₁/A₂] can be at least 1.01, such as at least 1.03, such as at least 1.05, such as at least 1.07, such as at least 1.1, such as at least 1.11, such as at least 1.12, such as at least 1.13, such as at least 1.14, such as at least 1.15, such as at least 1.2. As the aspect ratio [A₁/A₂] increases, the relative frontward extension of the lip 144 increases.

Referring again to FIG. 2A, a lateral side 154 of the mower deck 102 can rest along an outermost boundary 156 of the lawnmower 100. That is, the lateral side 154 of the mower deck 102 can define, or be close to, a lateral outermost point of the lawnmower 100. This allows the lawnmower 100 to cut close to neighboring objects. That is, by placing the mower deck 102 at a laterally outermost location of the lawnmower 100 and approximating a tip 158 of the blade 138 to the lateral side 154, the distance between the blade tip 158 and the neighboring object can be minimized. However, it is also desirable to maximize lateral spacing between the rear wheels 104A to increase mower stability, particularly for mowing on inclined and/or undulating surfaces. Thus, the rear wheel 104A is also disposed at or adjacent to the outermost boundary 156. As described in greater detail below, this can result in the rear wheel 104A passing over freshly cut grass discharged from the mower deck 102 which may result in the clumping of the discharged grass, or worse, compaction of the clumps.

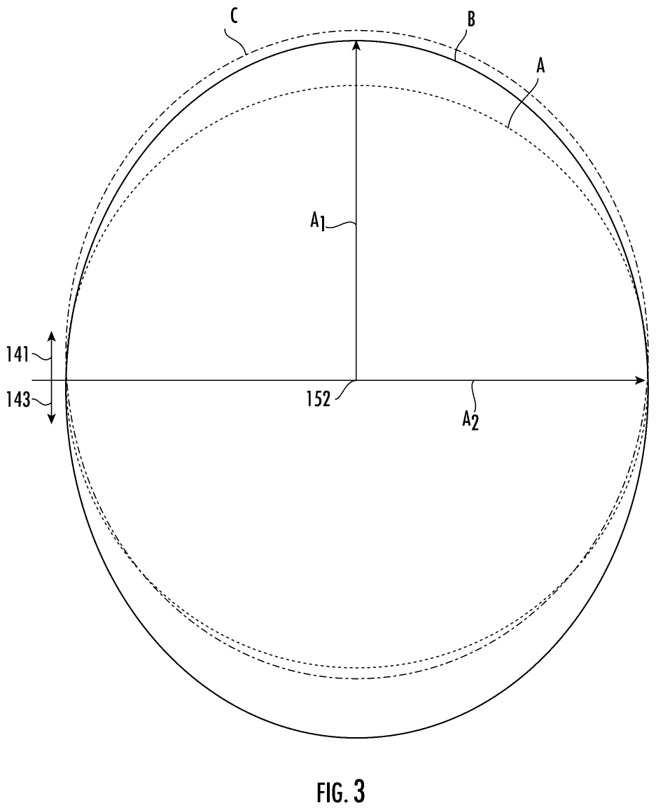

FIG. 4 depicts the blade 138 in two positions—a first position A extending in a lateral direction of the mower deck 102, and a second position B extending in a forward-rearward direction of the mower deck 102. A first tip distance D₁ between the tip 158 of the blade 138 in the first position A and the lip 144 is less than a second tip distance D₂ between the tip 158 and the blade 138 in the second position A and the lip 144. The difference between the first and second distances D₁, D₂ can correspond to the radial lengths A₁, A₂ described above.

In an embodiment, the forward portion of the lip 144, i.e., the portion of the lip 144 in front of the central vertex 152 can have a continuously arcuate shape, such as depicted in FIG. 4. In another embodiment, the forward portion of the lip 144 can have a segmented shape, including, for example, multiple linear portions joined together at relative angles between 1° and 179°.

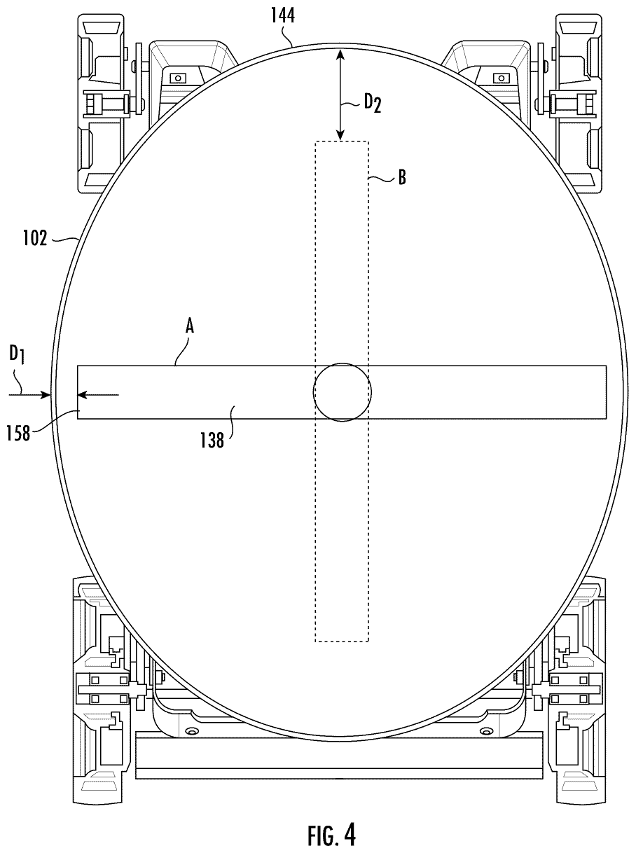

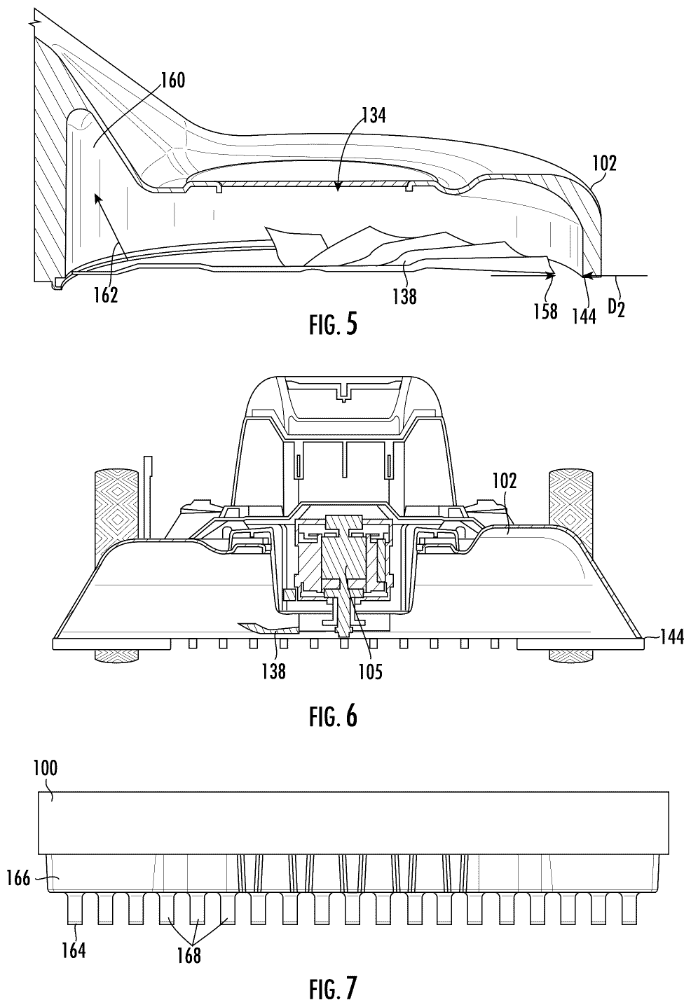

FIG. 5 illustrates a cross-sectional side view of the blade 138 within the mower deck 102, depicting the second tip distance D₂. In an embodiment, D₂ is at least 1 inch, such as at least 1.25 inches, such as at least 1.5 inches, such as at least 1.75 inches, such as at least 2 inches, such as at least 2.25 inches, such as at least 2.5 inches, such as at least 2.75 inches, such as at least 3 inches. In a particular embodiment, the second tip distance D₂ is at least 3.5 inches. It is believed that such large distances (and more particularly, distances exceeding 3 inches) result in a better, more consistent cut. Referring again to FIG. 4, the first tip distance D1 can be less than 2 inches, such as less than 1.5 inches, such as less than 1 inch, such as less than 0.75 inches, such as less than 0.5 inches, such as less than 0.25 inches, such as less than 0.1 inches.

Referring again to FIG. 5, the volume 134 of the mower deck 102 may define a rear airflow pocket 160 that reflects airflow 162 generated by movement of the blade 138 and directs the grass clippings in a desired direction. In an embodiment, the airflow pocket 160 can reflect the airflow downward and out of the volume 134 such that the clippings are caused to lie down with an even pattern in the lateral direction. This may prevent buildup of grass clippings along the lateral side 154 of the mower deck 102 (FIG. 2A).

Referring now to FIG. 2B, an example mower deck 102 having an elongated front end as described with respect to FIGS. 3 to 5 is depicted. The mower deck 102 defines no-cut zones 140 (e.g., one immediately behind the front lip 144 and another behind the motor 105), and cut zones 142. However, as compared to the -no-cut and cut zones 140, 142 of the mower deck 102 depicted in FIG. 2A, the front no-cut zone 140 terminates further forward relative to the blade 138.

In the circular mower deck 102 of FIG. 2A, the no-cut zone 140 extends significantly in a forward-rearward direction into a cutting region exposed to a cutting surface 167 of the blade 138. Approximately 50% of a front half of the blade 138 (i.e., the portion of the blade 138 shown in front of the motor 105) extends over the no-cut zone 140. And more particularly, the entire cutting surface 167 is disposed over the no-cut zone 140 when the blade 138 is oriented in the forward-rearward direction. As a result, grass travels deeper into the mower deck 102 prior to being cut.

Conversely, the front half of the blade 138 of the mower deck 102 of FIG. 2B with the extended front end allows the grass blades to return from bent (i.e., no-cut zone 140) to a cuttable height (i.e., the cut zone 142) prior to reaching 25% of the front half of the blade 138. That is, the no-cut zone 140 terminates in a forward-rearward direction without extending beyond 25% of the blade 138 when the blade 138 is oriented in the forward-rearward direction, such as without extending beyond 20% of the blade 138 when the blade 138 is oriented in the forward-rearward direction, such as without extending beyond 15% of the blade 138 when the blade 138 is oriented in the forward-rearward direction, such as without extending beyond 10% of the blade 138 when the blade 138 is oriented in the forward-rearward direction, such as without extending beyond 5% of the blade 138 when the blade 138 is oriented in the forward-rearward direction, such as without extending beyond 3% of the blade 138 when the blade 138 is oriented in the forward-rearward direction, such as without extending beyond 1% of the blade 138 when the blade 138 is oriented in the forward-rearward direction. In an embodiment, the no-cut zone 140 terminates at or prior to the blade tip 158 when the blade 138 is oriented in the forward-rearward direction. For example, the no-cut zone 140 may terminate in front of the blade tip 138. As such, the cutting surface 167 of the blade 138, and more particularly the cutting surface 167 immediately adjacent to the tip 158 of the blade 138, continuously cuts grass along each rotational cycle without passing over any no-cut zones 140. As a result, grass is subjected to several additional passes by the blade 138, thereby increasing cut quality and clumping. Additionally, fluctuations at the motor 105 as a result of cycling between relatively greater and lesser load (i.e., as a result of repeatedly cycling the blade through no-cut zones and cut zones) is reduced and the motor is subjected to a smoother operating curve. This may prolong motor life and increase battery performance. While the above-description is made with respect to a percentage of blade overlap at an interface of the no-cut zone 140 and cut zone 142 (i.e., a forwardmost location of the blade 138 at which initial cutting is achieved), it should be understood that such limitation is generally made with reference to an average cut size (i.e., how much of the grass blade is being removed) or an average range of cut sizes. For instance, homeowners and lawn service technicians typically cut grass on a weekly or bi-weekly schedule. As such, the cut size is frequently 2 inches or less. However, circumstances may arise where the cut size is significantly greater, such as 6 inches or more, such as when the grass has been left uncut for three or more weeks and/or upon heavy rain. In these instances, the embodiments described herein still improve cut performance, however, the interface between the no-cut zone 140 and the cut zone 142 is deeper into the travel of the mower deck 102 than as shown in FIG. 2B. The user may account for this extra cut size by raising the mower deck height for a first pass and then lowering the mower deck height for a second pass, with each pass exhibiting improved cut performance as compared to a traditional mower deck.

FIG. 6 illustrates the mower deck 102 as seen with a flared lip 144. The flared lip 144 creates a sloped exit for grass clippings to discharge in an outward direction. The sloped exit prevents the grass clippings from redistributing back into the blade 138 to reduce load on the motor 105 to prevent motor bog, which may occur in thick or heavy grass. In an embodiment, the flared lip 144 can extend around the entire perimeter of the mower deck 102. In other embodiments, the flared lip 144 may not extend fully around the mower deck 102. For example, the flared lip 144 can unflare (i.e., return to a vertical, or near vertical, orientation) at one or more locations corresponding to the wheels 104. Additionally, the flared lip 144 can unflare at the front and/or rear ends of the mower deck 102. By unflaring the lip 144 at the front and/or rear ends of the mower deck 102, the mower deck 102 may occupy a lesser length, allowing traversal over a rougher, more undulating terrain.

Conditioning the grass prior to cutting may further enhance cut quality. Referring to FIGS. 7 and 8, a rake 164 can be implemented at the front of the lawnmower 100 to help raise matted grass and comb the grass into a more suitable condition prior to cutting. The rake 164 may also catch debris, such as rocks, sticks, and trash, and cause the debris to move around the mower deck 102 to avoid impact with the blade 138. In an embodiment, the rake 164 includes a hub 166 and a plurality of projections, e.g., teeth 168, extending from the hub 166. The teeth 168 can be arranged and spaced apart from one another at fixed intervals in the lateral direction. In an embodiment, the teeth 168 can include a multi-row configuration, including, for example, a first row 170 of teeth 168 and a second row 172 of teeth 168. In some implementations, the first and second rows 170, 172 of teeth 168 can share a common size, a common shape, or both. In other implementations, the first and second rows 170, 172 of teeth 168 can be different from one another. For example, the first row 170 of teeth 168 can extend further than the second row 172. Alternatively, or in addition, a spacing between adjacent teeth 168 in the first row 170 can be smaller than the second row 172.

In addition to improving quality of cut, embodiments described herein improve management of grass clippings, and more particularly can provide improved distribution of cut grass along the underlying ground surface G.

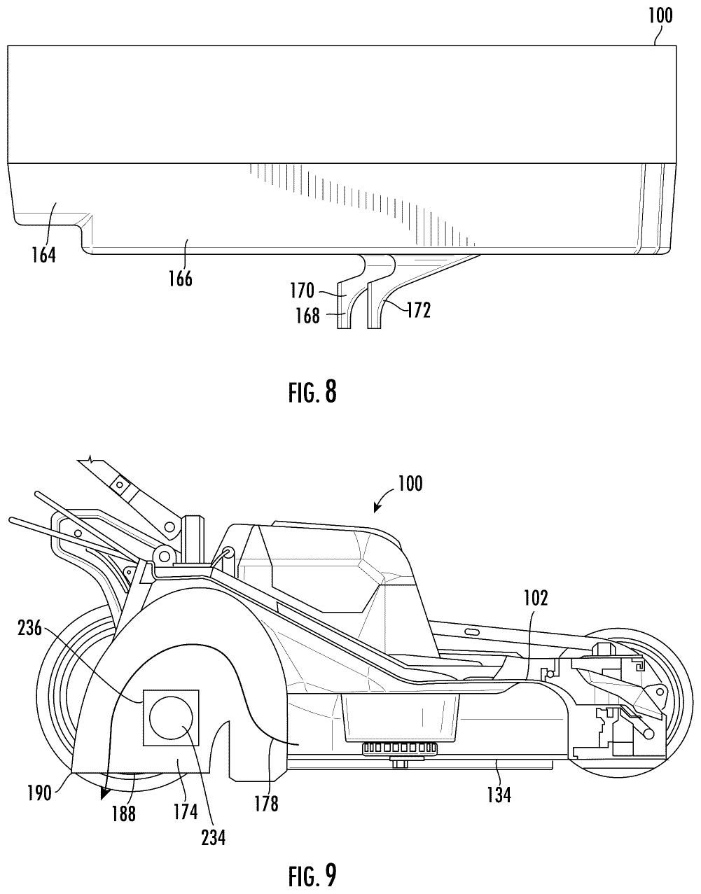

Referring to FIGS. 9 to 11, a diffuser 174 may be removably coupled to the lawnmower 100 at a rear end of the mower deck 102. In an embodiment, the diffuser 174 is coupled to the lawnmower 100 using the same attachment structure that receives the bag 130 (FIG. 1). In another embodiment, the diffuser 174 may be coupled to the lawnmower 100 using a different attachment structure, such as a specific diffuser attachment structure. The diffuser 174 may include attachment hardware 176 that permits attachment of the diffuser 174 to the lawnmower 100. By way of non-limiting example, the attachment hardware 176 can include a snap fit, a hook, a threaded or non-threaded fastener, an interference element configured to form an interference fit with the lawnmower 100, a cable or rope tie, hook and loop fastener (e.g., Velcro), or the like.

In an embodiment, the diffuser 174 define a hard shell formed from a relatively rigid material like a polymer. The hard shell can be segmented into a plurality of pieces that can be disassembled for storage. Alternatively, or in addition, the hard shell can include one or more fold areas which permit collapse of the hard shell for storage. In an embodiment, the diffuser 174 can include a soft material, such as a fabric. The soft material can be supported by a rigid frame to maintain the soft material in a desired shape and to resist deflection when exposed to airflow generated by the blade 138 during use of the lawnmower 100.

The diffuser 174 redirects grass clippings from the volume 134 of the mower deck 102 in a more suitable manner than random discharge based on mower deck geometry. The diffuser 174 disperses airflow 178 to create a diffusion pattern 180 of the clippings behind the lawnmower 100. By way of non-limiting example, the diffuser 174 can create a diffusion pattern 180 with a gaussian distribution (i.e., a symmetrical bell-shaped curve), a linear skewed curve left or right, a log-normal distribution skewed left or right, a uniform distribution, a binomial distribution, a multinomial distribution, or the like. In this regard, the clipping discharge can be deposited on the underlying ground surface G in predetermined diffusion patterns. Different types of grass may benefit from different diffusion patterns 180. For example, relatively stiffer grass blades may prefer one type of diffusion pattern 180 for ideal aesthetic and lay while relatively softer grass blades may prefer another type of diffusion pattern for ideal aesthetic and lay. Similarly, different cut conditions may warrant a different type of diffusion pattern 180. For example, wet grass clippings may perform better with one type of diffusion pattern 180 (e.g., a uniform distribution) while dry grass clippings may perform better with another type of diffusion pattern 180 (e.g., a gaussian distribution). The user may be able to switch between different diffusion patterns 180 at the diffuser 174, such as for example, by adjusting a louver 182 or other pattern defining feature of the diffuser 174. By way of example, the louver 182 may be pivoted to adjust the diffusion pattern 180. Alternatively, or in addition, the user may be able to select between a plurality of different diffusers 174 to affect the diffusion pattern 180. Thus, the user can swap an existing diffuser 174 for a new diffuser 174 based on grass type, cut conditions, or preferred aesthetic.

As shown in FIG. 10, the diffuser 174 can have a shape to accommodate existing structure of the lawnmower 100. For example, the diffuser 174 can define a cutout 184 to accommodate a drive motor 186 that propels the rear wheels 104A. The discharge end 188 of the diffuser 174 may similarly include the cutout 184, but may optionally extend across the entire lateral dimension at a rearmost end 190 of the diffuser 174.

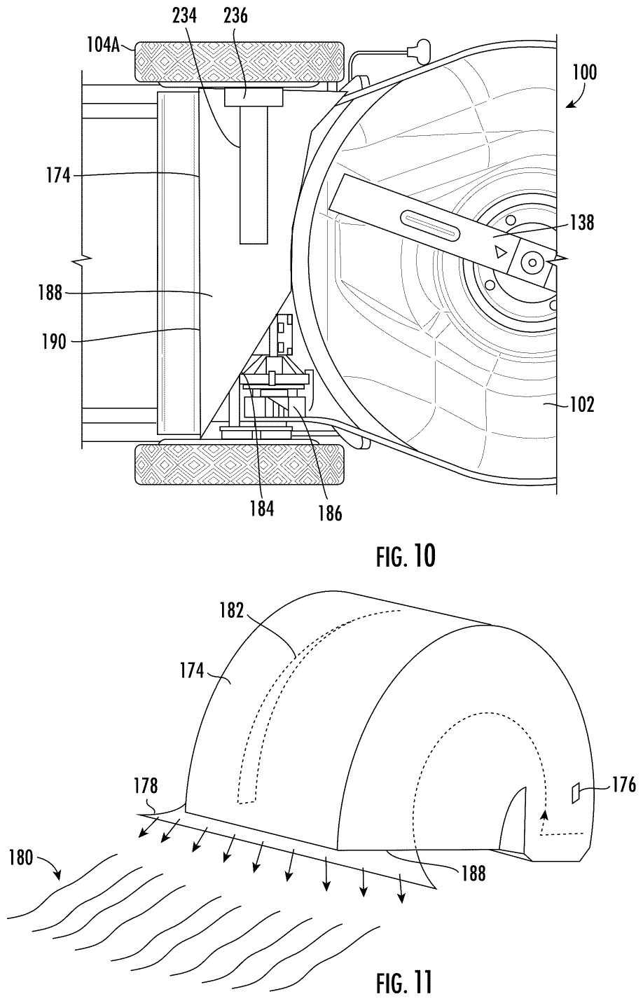

In some implementations, the diffuser 174 is passive, i.e., the diffuser may direct airflow without any powered means. In other implementations, the diffuser 174 is active. Active, as used with reference to the diffuser 174, is meant to refer to generation of airflow or reconditioning of airflow by a powered element. Referring to FIGS. 10 and 11, in one or more implementations, the diffuser 174 can include an agitator 234. The agitator 234 may extend across at least a portion of the airflow 178 and interact therewith, or even propel the airflow. In some instances, the agitator 234 may extend at least 25% across a lateral dimension of the diffuser 174, such as at least 50% of the lateral dimension, such as at least 75% of the lateral dimension. In an embodiment, the agitator 234 extends across the entire lateral dimension of the diffuser 174, i.e., between opposite lateral walls of the diffuser 174.

The agitator 234 may be coupled to sidewall(s) of the diffuser 174 by a low friction interface, such as a bearing. The bearing 234 can permit easier movement, e.g., rotation, of the agitator 234. In some implementations, the bearing 234 can include a one-way bearing. In other implementations, the bearing 234 is unrestricted and can permit rotation of the agitator 234 in either rotational direction.

By way of non-limiting example, the agitator 234 can include a tined-structure having a central hub from which a plurality of tines project. The tines can be formed, for example, from metal wire. In another embodiment, the agitator 234 can include a fan or airflow generating element. The fan may be mechanically configured to generate different airflow to affect the diffusion pattern 180. For instance, the fan can have blades with different sizes, different shapes, or both. The different sized/shaped blades can be positioned along the agitator 234 to generate the diffusion pattern 180. For example, the central blades can be configured to generate stronger airflow to propel debris stronger towards the ground to create a bimodal diffusion pattern 180 at outer ends of the diffuser 174. Conversely, the laterally outer blades located in operation nearest the lateral edges of the lawnmower 100 can be configured to generate strong airflow to propel debris in a central direction to create a gaussian distribution. In another embodiment, the agitator 234 can include sharpened blades which rotate through the airflow 178. As the sharpened blades impact debris discharged from the mower deck 102, the sharpened blades break up the debris. In an embodiment, the agitator 234 can include a broom or broom-like structure that sweeps the airflow 178 to comb the debris or sweeps a surface of the diffuser 174 to clear the surface of built-up debris. Yet other agitator structure may be used with the diffuser 174 to achieve a desired airflow, clump removal, or other desirable effect.

In some instances, the agitator 234 is disposed entirely within the body of the diffuser 174 such that no portion of the agitator 234 extends from the diffuser 174. In other instances, the agitator 234 may extend out of the diffuser 174 such as out of the discharge end 188 towards the underlying ground surface. In these instances, the agitator 234 may provide anti-clumping benefits to debris already disposed on the underlying ground surface. For example, the agitator 234 may break up debris which clumped upon discharged upstream of the agitator 234 when the mower deck 102 passed thereover.

The agitator 234 can be driven by a powered device, such as a motor 236. The motor 236 may power the agitator 234 to spin, e.g., about a central axis. The motor 236 may be a fixed (single) speed motor or a variable speed motor. In some implementations, the motor 236 may be controlled from one of the user implements on the handle 106. For example, the user may activate or deactivate the motor 236 using a switch, such as a toggle, disposed on the handle 106. Alternatively, or in addition, the user may be able to switch between different operating speeds to control the affect of the agitator 234 on the airflow 178. In some implementations, the motor 236 may be configured to receive control instructions that adjust a variable speed of the motor in response to one or more conditions, such as, for example, a clumping factor detected by a sensor of the lawnmower. The clumping factor can refer to how likely the cut debris is to clump and/or how much clumping is actively occurring during use of the lawnmower. The motor 236 may be controlled, e.g., by a motor controller, to affect different speeds in response to the clumping factor or another similar characteristic.

In another embodiment, the agitator 234 can be driven by another element of the lawnmower 100, such as for example a motor 238 propelling the rear wheels 104A (FIG. 2A). For instance, the rear wheels 104A may be coupled together through a drive shaft 240. The agitator 234 can be coupled with the drive shaft 240 (e.g., through a belted or geared interface), or even directly with the motor 238, so as to receive motive power therefrom. In an embodiment, the agitator can be subjected to a gear ratio that permits the agitator 234 to rotate faster than the rear wheels 104A. For example, the gear ratio can be at least 1:10 such that the agitator 234 rotates 10 times faster than the rear wheels 104A. Other example gear ratios include 1:1.1, 1:2, 1:5, 1:15, 1:20, 1:25, 1:50, 1:100, or the like. Additionally, the gear ratio between the rear wheel 104A and the agitator 234 can be in a range between any of the above described values.

In some implementations, the agitator 234 may be operable in only a single direction. For example, the agitator 234 may only rotate in a clockwise or counter-clockwise direction. In other implementations, the agitator 234 may be configured to rotate in different directions, such as in the clockwise direction and the counterclockwise direction. The user may be able to select between the direction of rotation. Alternatively, or in addition, the motor 236 may receive a control instruction which causes the motor 236 to rotate in one of the two directions. In some instances, the direction of rotation may affect clump breakup. By switching between the rotation directions, the lawnmower 100, and more particularly the agitator 234, is better able to deal with clumping and distribute a more even, aesthetic discharge of clippings.

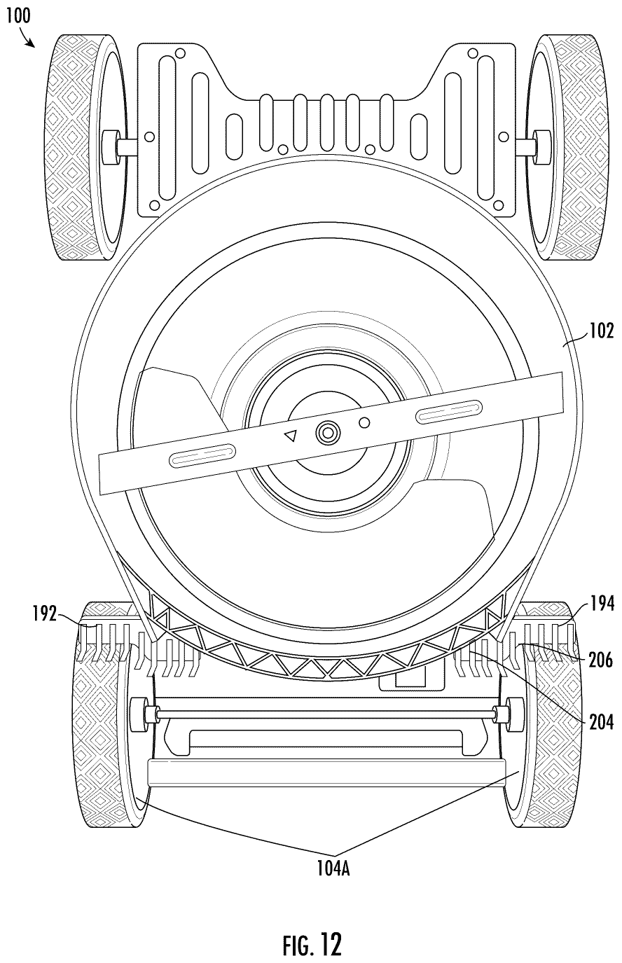

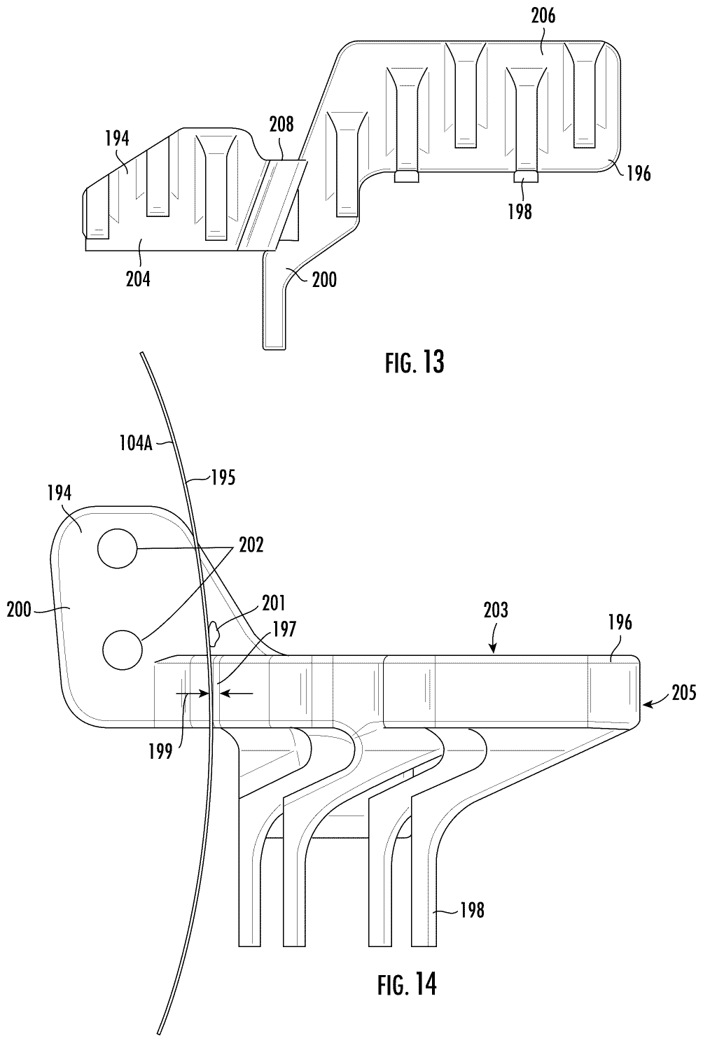

FIG. 12 illustrates a bottom view of the lawnmower 100 as seen with rear rakes 192, 194 in position. The rear rakes 192, 194 are coupled to the lawnmower 100 at a location in front of each of the rear wheels 104A. FIG. 13 illustrates a bottom view of the rear rakes 194. FIG. 14 illustrates a side view of the rear rake 194. FIG. 15 illustrates a perspective view of the rear rake 194. While the following description is made with respect to the rear rake 194, the other rear rake 192 may include any one or more characteristics as described with respect to the rear rake 194. In some implementations, the other rear rake 192 may be mirrored to perform a similar function as the rear rake 194 at the other rear wheel 104A.

The rear rake 194 includes a hub 196 and a plurality of teeth 198 extending from the hub in a downward direction. The teeth 198 can include one row of teeth, two rows of teeth, three rows of teeth, etc. The teeth 198 can be spaced apart from another by fixed or variable distances.

A flange 200 extends from the hub 196. The flange 200 can define attachment structure, such as openings 202 that permit attachment of the rear rake 194 to complementary attachment structure of the lawnmower 100. In some implementations, the attachment structure and complementary attachment structure are configured to form a permanent attachment, such that the rake 194 remains coupled to the lawnmower 100 at all times. Permanent attachment may be achieved, for example, using a bolt and nut. It should be understood that permanent attachment does not require inseparable attachment, but is intended to reference an attachment scheme that does not involve rapid removal of the rake 194. In another implementation, the rake 194 can be attached to the lawnmower 100 through a quick detach connection. The quick detach connection allows the user to selectively deploy the rake 194 in situations where use of the rake 194 would be beneficial, such as when the grass is wet or tall and the likelihood of clumping is increased.

Referring to FIG. 13, the rake 194 may include a plurality of pads, such as a first pad 204 and a second pad 206. The first and second pads 204, 206 may be attached together or formed from a single (monolithic) piece. The first pad 204 can define an internal rake and the second pad 206 can define an external rake. Internal and external as referenced to the rake may refer to a lateral position, i.e., laterally internal and laterally external, respectively. That is, referring again to FIG. 12, the first pad 204 can occupy an inboard position and the second pad 206 can occupy an outboard position. The first and second pads 204, 206 may be interposed by a channel 208. The channel 208 may extend in a generally front-to-rear orientation and fit along the lip 144 (FIG. 2A) of the mower deck 102. Sidewalls of the channel 208 may form a close fit with the profile of the mower deck 102 to prevent the rake 194 from rattling or moving. The sidewalls of the channel 208 can also provide stability against twisting when the rake 194 encounters a rigid and/or unmovable object (e.g., a rock).

The first pad and second pads 204, 206 interact with grass clippings dispersed on the underlying ground surface. The first pad 204 can interact with grass clippings located inside of the rear wheel 104A (i.e., grass clippings that would not be impacted by the rear wheel 104A during straight path mowing) and the second pad 206 can interact with grass clippings that are likely to be ridden over by the rear wheel 104A regardless of a direction of travel. The dispersed grass, whether interacting with the first or second pad 204, 206 may be dispersed more heavily along the lateral edges of the mower deck 102, particularly when the diffuser 174 is not in use. The rake 194 acts to disperse the clippings prior to the lawnmower 100 fully moving thereby. In this regard, the dispersion pattern of clippings deposited at the edge of cut can be softened to reduce the buildup of sharp lines that form as a result of lateral discharge.

The second pad 206 can also precondition the clippings prior to interaction with the rear wheel 104A, i.e., prior to the rear wheel 104A passing thereover. For example, traditionally clumped grass that is run over by the lawnmower, e.g., by one of the wheels 104, may become packed down. Packed down grass, particularly when wet, is difficult to disperse by traditional means like blowing. As a result, the packed grass often remains in position until some later time, e.g., when the lawn is again mowed. Unfortunately, packed grass frequently kills the underlying grass. Thus, leaving packed grass on the ground may result in the formation of lines along the ground. To mitigate any such packing of grass under the weight of the lawnmower 100 as experienced by the rear wheel 104A riding thereover, the second pad 206 can precondition the clippings to break up clumps and more evenly disperse the clippings prior to the wheel 104A passing thereabove. In some instances, the teeth 198 of the second pad 206 can be arranged to direct clippings laterally inward and/or laterally outward to avoid the rear wheel 104A altogether. As shown in FIG. 12, the second pad 206 may be positioned forward of the first pad 204 such that clippings are directed laterally inward towards the first pad 204. The first pad 204 may then disperse the clippings without having to address passage of the rear wheel 104A thereabove. In other instances, the teeth 198 of the second pad 206 may not direct the clippings laterally, but instead break up clumps while leaving the clippings in the path of the rear wheel 104A.

The rake 194, or a portion thereof, may be arranged in close proximity to the rear wheel 104A, such as in close proximity to a tread of the rear wheel 104A. In an embodiment, the rake 194 can be disposed immediately in front of the rear wheel 104A. For example, FIG. 14 depicts a representation of an edge of the tread 195 of the rear wheel 104A as seen with respect to the rake 194. As depicted, a rear surface 197 of the rake 194 is spaced apart from the tread 195 by a nominal gap 199. The nominal gap 199 may be at least 0.1 inches, such as at least 0.2 inches, such as at least 0.3 inches, such as at least 0.4 inches, such as at least 0.5 inches. The gap 199 may be less than 1 inch, such as less than 0.5 inches, such as less than 0.25 inches. In an embodiment, the nominal gap 199 may be less than 0.1 inches or even 0 inches.

As the rear wheel 104A rotates, detritus 201 collecting along the tread 195 that extends from the tread by a distance greater than the size of the gap 199 impacts the rake 194. The result of this impact is the removal (e.g., scraping) of the detritus 201 from the tread 195. In some instances, the detritus 201 can fall onto a top surface 203 of the rake 194. Detritus 201 can build up on the top surface 203 and be incrementally advanced forward, falling off the front end 205 of the rake 194 and into the path of the teeth 198. Alternatively, detritus 201 can be guided along the top surface 203 (or another surface) in a lateral direction, e.g., towards or away from a centerline of the lawnmower.

By removing detritus 201 from the tread 195, the rear wheel 104A is prevented from impacting debris into the yard. Without detritus removal from the rear wheels 104A, the buildup often increases until large clumps form. These large clumps then become deposited (or worse, compacted) onto the underlying ground surface. Such clumps are often difficult to remove using light force and may require the user to expend significant amounts of effort to remove.

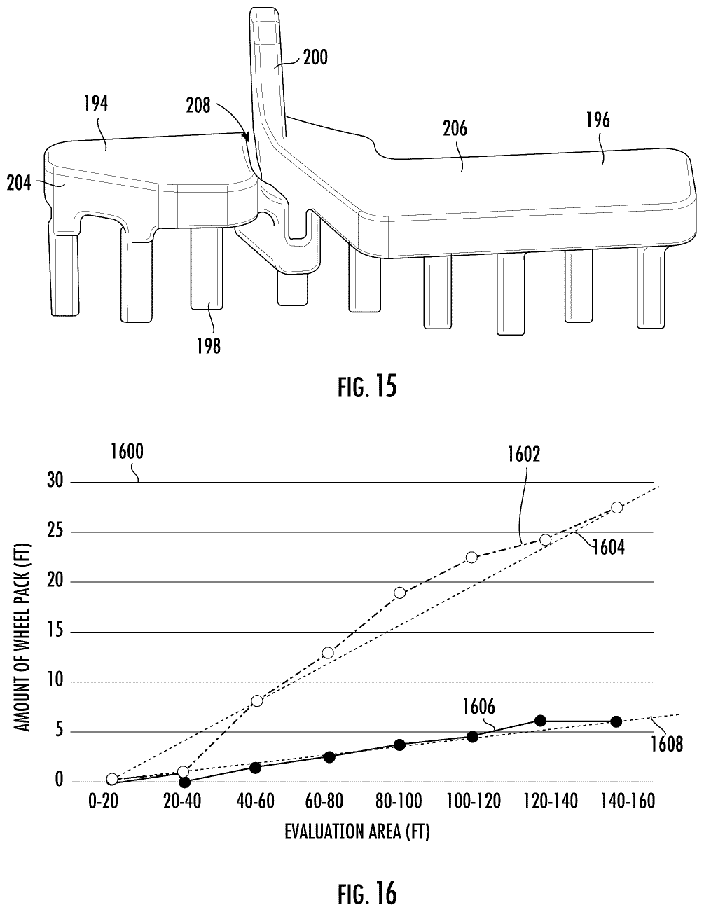

FIG. 16 illustrates a chart 1600 plotting cumulative buildup of wheel pack over a mowed distance. Wheel pack is observed as packed down clumps formed as a result of the rear wheel 104A riding over clumps of deposited grass. The X-axis is distance of travel (as measured in feet). The Y-axis is the amount of wheel pack (as measured in feet). Using traditional methods, i.e., without rake 194, (hereinafter referred to as control 1602) cumulative wheel pack increases relatively consistently over the distance of travel. That is, the control 1602 references against a generally straight line 1604. Thus, as the lawnmower travels, the control 1602 results in a continuous and predictable buildup of wheel pack. Using the rake 194 in the same cut conditions, on the same mowing area, at the same time, using the same lawn mower (hereinafter referred to as rake 1606), cumulative wheel pack is significantly reduced over the distance of travel. While rake 1606 references against a generally straight line 1608, the generally straight line 1608 is significantly less steep. As a result, the rake 1606 results in a continuous and predictable buildup of wheel pack less than the control 1602. Table 1 illustrates the control 1602 and rake 1606 as a function of distance travelled.

TABLE 1
Wheel Pack

| Distance | Control Wheel | Rake Wheel |
|---|---|---|
| (ft) | Pack (ft) | Pack (ft) |
| 20 | 1.5 | 0 |
| 40 | 7 | 2 |
| 60 | 12 | 3 |
| 80 | 18 | 4 |
| 100 | 22.5 | 5 |
| 120 | 24 | 6 |
| 140 | 27 | 5.5 |

At 140 feet, the rake 1606 accumulated 5.5 feet of wheel pack as compared to 27 feet of wheel pack for the control 1602. The rake 1606 thus improved performance as it relates to wheel pack by more than 79%.

FIG. 17 illustrates the lawnmower 100 with a trailing conditioner 210 coupled to and extending from a rear side of the mower deck 102. The trailing condition 210 extends from a relatively higher vertical elevation at the mower deck 102 to a relatively lower elevation at a rear end of the trailing conditioner 210. The trailing conditioner 210 rests on the underlying ground surface G and is dragged therealong by forward movement of the lawnmower 100. The trailing condition 210 is not powered and, in certain implementations, may omit any moving parts.

The trailing conditioner 210 may define a sheet, such as a rigid or semi-rigid sheet. The sheet can be formed, for example, from a metal or polymer. In some implementations, the trailing conditioner 210 can include a flexible sheet, e.g., formed from a flexible material or formed from a rigid material having a segmented design including separate pieces movably coupled together. The sheet can include openings, such as perforations 212. The perforations 212 may be evenly distributed along an area of the sheet. The perforations 212 can extend through the entire thickness of the sheet. The perforations 212 may define circular shapes, polygonal shapes, or yet other shapes. In an embodiment, the sheet can define a high density of perforations, such as for example, an average perforation density of between 1 perforation per square inch and 100 perforations per square inch, such as between 2 perforations per square inch and 50 perforations per square inch, such as between 5 perforations per square inch and 20 perforations per square inch, such as between 6 perforations per square inch and 10 perforations per square inch. In some implementations, the perforations 212 are evenly distributed across the sheet. In other implementations, the perforations 212 may be variably distributed across the sheet. For example, the center of the sheet can have a relatively higher perforation density and the lateral edges of the sheet can have a relatively lower perforation density. Alternatively, the center of the sheet can have a relatively lower perforation density and the lateral edges of the sheet can have a relatively higher perforation density.

In an embodiment, the sheet comprises metal and the perforations 212 are formed by expanding the metal, i.e., the sheet comprises expanded metal. The perforations 212 catch grass clumps as the sheet passes thereover. The grass clumps, or individual blades thereof, become engaged with the perforations 212 such that the grass clumps are pulled apart as the sheet moves over the grass clump. The sheet can further distribute the grass clippings more evenly across the underlying ground surface G.

In an embodiment, the sheet extends within confines defined by laterally inner sidewalls of the rear wheels 104A. In another embodiment, the sheet can extend past the rear wheels 104A and flare laterally outward beyond the inner sidewalls of the rear wheels 104A, similar to an inverted T-shape. In this regard, any clumping that is packed down by the rear wheels 104A can be passively broken up by further travel of the lawnmower 100.

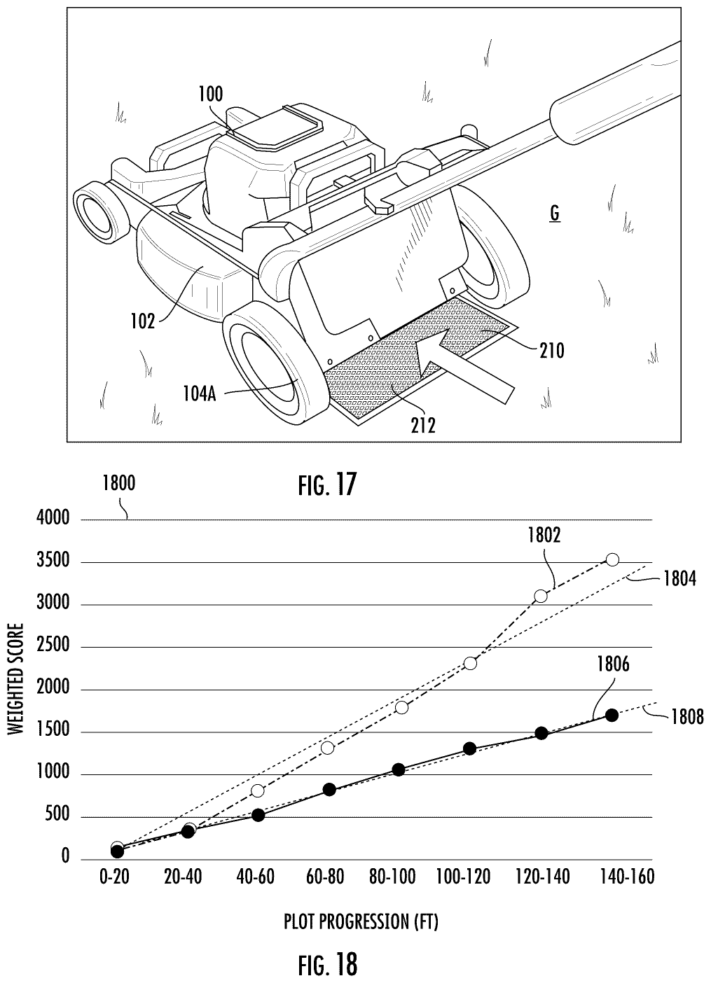

FIG. 18 illustrates a chart 1800 plotting an observed score assigned to a grass distribution left behind a lawn mower during mowing operations. The observed score factors clipping distribution, aesthetic, and clumping. The lower the score, the better. The X-axis is distance of travel (as measured in feet). The Y-axis is the observed score (unitless). Using traditional methods, i.e., without trailing conditioner 210, (hereinafter referred to as control 1802) observed score increases relatively consistently over the distance of travel. That is, the control 1802 references against a generally straight line 1804. Thus, as the lawnmower travels, the control 1802 results in a continuous and predictable increase in observed score. Using the trailing conditioner 210 in the same cut conditions, on the same mowing area, at the same time, using the same lawn mower (hereinafter referred to as trailing conditioner 1806), observed score is significantly reduced over the distance of travel. While trailing conditioner 1806 references against a generally straight line 1808, the generally straight line 1808 is significantly less steep. As a result, the trailing conditioner 1806 results in a continuous and predictable observed score less than the control 1802. Table 2 illustrates the control 1802 and trailing conditioner 1806 as a function of distance travelled.

TABLE 2
Observed Score

| | | Trailing |
|---|---|---|
| Distance | Control | Conditioner |
| (ft) | Score | Score |
| 20 | 350 | 350 |
| 40 | 800 | 500 |
| 60 | 1350 | 800 |
| 80 | 1750 | 1050 |
| 100 | 2300 | 1300 |
| 120 | 3100 | 1500 |
| 140 | 3550 | 1700 |

At 140 feet, the trailing conditioner 1806 accumulated an observed score of 1700 as compared to an observed score of 3550 for the control 1802. The trailing conditioner 1806 thus improved performance as it relates to the observed score by more than 50%. Additionally, referring to FIG. 18, the trailing conditioner 1806 was less variable and provided a more consistent weighted score, i.e., the trailing conditioner 1806 deviated from the generally straight line 1808 by significantly less than the control 1802.

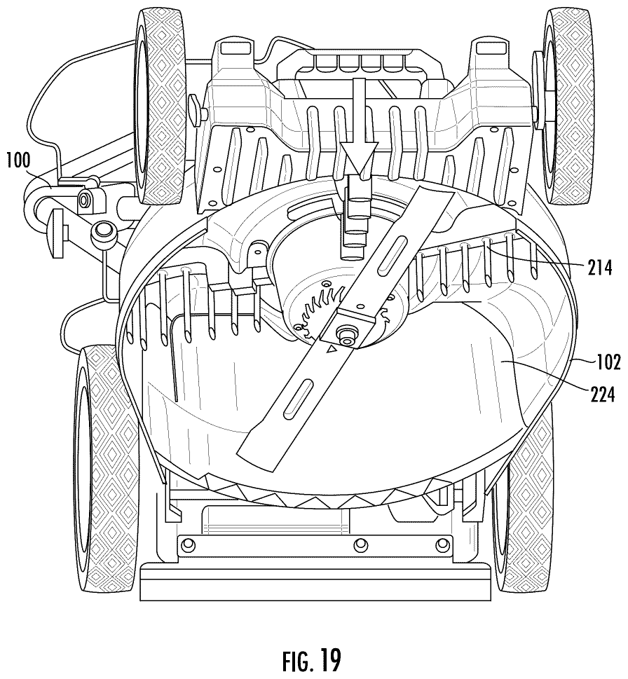

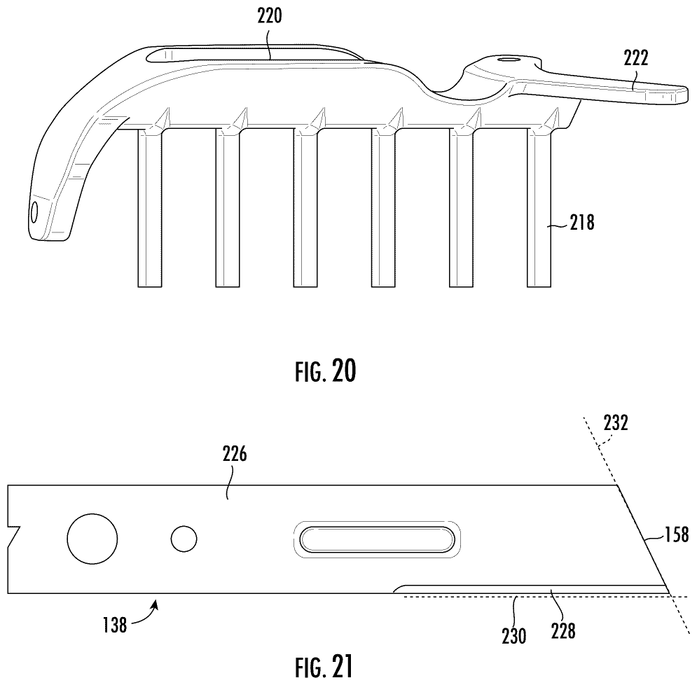

FIG. 19 depicts the lawnmower 100 with an agitator assembly 214 disposed within the volume 134 of the mower deck 102. FIG. 20 is a perspective view one an agitator 216 that may form a part, or whole, of the agitator assembly 214. Referring to FIGS. 19 and 20, the agitator assembly 214 can include blades 218 that extend into the volume 134. Adjacent blades 218 are separated by gaps. As debris moves within the volume 134, as driven by the blade 138, the debris impacts the blades 218, causing the debris to break apart into smaller pieces. Particularly, for grass clumps, this can reduce the size of the clump and result in compacted grass clumps breaking into separate, individual blades of grass before being deposited onto the underlying ground surface.

In the illustrated embodiment, the agitator 216 includes a base 220, individual blades 218 extending from the base 220, and an attachment structure 222 that allows the agitator 216 to be coupled to the mower deck 102. In an embodiment, the attachment structure 222 may include openings through which fasteners are inserted and threadably received at the mower deck 102. In other embodiments, the attachment structure 222 may include channels for receiving adhesive, a snap fit connection, a bayonet-style connection, features for interference with the mower deck 102, or the like

The agitator assembly 214 may be installed at an underside 224 of the mower deck 102. Alternatively, or in addition, one or more portions of the agitator assembly 214 may be installed from the top side of the mower deck 102. The top side is opposite the underside 224. By way of example, the mower deck 102 can define openings through which the blades 218 are passed to install the agitator assembly 214.

FIG. 21 illustrates a plan view of a portion of the blade 138. In particular, FIG. 21 illustrates the tip 158 of the blade 138. The blade 138 generally includes a body 226 defining a cutting surface 228. The cutting surface 228 may extend along a lateral aspect of the body 226 and terminate at, or near, the tip 158. The cutting surface 228 may lie along a reference line 230. The tip 158 can lay along a tip reference line 232. An angle formed between the reference line 230 and the tip reference line 232 may be less than 90°, such as less than 85°, such as less than 80°, such as less than 75°, such as less than 70°, such as less than 68°, such as less than 65°. In a particular embodiment, the angle formed between the reference line 230 and the tip reference line 232 may be less than or equal to 64°. The angle may be at least 30°, such as at least 40°, such as at least 50°, such as at least 60°. Moreover, the angle can be within any range defined between any of these values. Angles in a range of 45° and 70°, such as angles in a range of 60° and 68°, may produce superior cuts in the individual grass blades. In particular, as the angle approaches but remains less than 64°, the cutting surface 228 exhibits improved cutting performance, particularly near the tip 158. By way of non-limiting example, this improvement may relate to improved airflow balance at the tip 158 and a better grass position as a result thereof.

Lawnmowers using systems and components described herein exhibit overall improved cutting performance, improved grass aesthetic, and/or improved management of grass clippings, particularly when the bag is not attached to the lawnmower and the clippings are deposited directly onto the underlying ground surface. The lawnmowers can reduce clumping, reduce mowing stripes formed by accumulated clippings, and/or reduce pack down of clippings. The lawnmowers may allow for tailored lawn appearance through selection of a plurality of different combinations of attachments and features. The lawnmowers can mow for greater durations of time without exhibiting clogging or bogging at the mower deck or driving element. The lawnmowers can reduce tracking of mud and debris. These and other benefits allow the user to have a better mowing experience while simultaneously creating a better quality outcome without having to exert additional work. Moreover, the lawnmowers can reduce the amount of cleanup required after the completion of mowing, both within the yard and at the lawnmower itself.

Further aspects of the invention are provided by one or more of the following embodiments:

A lawnmower comprising: a mower deck defining a volume; a driving element configured to drive a cutting implement within the volume; a plurality of wheels supporting the mower deck; and a handle extending in a rearward direction from the mower deck, wherein the mower deck defines a first radial length A₁, as measured from a central vertex of the cutting implement to a front lip of the mower deck, and a second radial length A₂, as measured from the central vertex to a lateral lip of the mower deck, wherein an aspect ratio of the first and second radial lengths [A₁/A₂] is at least 1.05, and wherein a tip distance, as measured between the front lip of the mower deck and a nearest part of the cutting implement when the cutting implement extends in a forward-rearward direction, is at least 1.5 inches.

The lawnmower of any one or more of the embodiments, wherein the aspect ratio of the first and second radial lengths [A₁/A₂] is at least 1.1, and wherein a lateral tip distance, as measured between the lateral lip of the mower deck and the nearest part of the cutting implement when the cutting implement extends in a lateral direction, is less than 0.5 inches.

The lawnmower of any one or more of the embodiments, wherein the lawnmower further comprises a rake disposed in front of one of the plurality of wheels, the rake defining a plurality of projections arranged in front of the wheel and extending towards an underlying ground surface.

The lawnmower of any one or more of the embodiments, wherein the rake is spaced apart from a tread of the wheel by a gap of less than 1 inch, and wherein the rake is configured to remove detritus from the tread as the wheel rotates.

The lawnmower of any one or more of the embodiments, wherein the rake extends laterally inward past the wheel, laterally outward past the wheel, or both laterally inward past the wheel and laterally outward past the wheel.

The lawnmower of any one or more of the embodiments, wherein the lawnmower further comprises a diffuser, wherein the diffuser is removably disposed at a rear end of the mower deck in communication with the volume, and wherein the diffuser disperses airflow generated by the cutting implement to create a diffusion pattern of clippings on an underlying ground surface.

The lawnmower of any one or more of the embodiments, wherein the diffuser comprises an agitator configured to at least partially generate the diffusion pattern, and wherein the diffusion pattern is selectable between a plurality of different diffusion patterns.

The lawnmower of any one or more of the embodiments, wherein the lawnmower further comprises a trailing conditioner hanging from a rear end of the mower deck, the trailing conditioner comprising a sheet defining a plurality of perforations, and wherein the perforations are configured to receive grass blades such that any grass clumps are pulled apart by force imparted on the received grass blades by movement of the sheet over the underlying ground surface.

The lawnmower of any one or more of the embodiments, wherein the lawnmower further comprises a trailing conditioner hanging from a rear end of the mower deck, the trailing conditioner comprising a flexible mass that hangs behind the mower deck and has a major surface that pulls along an underlying ground surface, and wherein the sheet comprises a plurality of perforations.

The lawnmower of any one or more of the embodiments, wherein the cutting implement comprises a blade, wherein the blade comprises a cutting surface that extends along a reference line, wherein the blade comprises a blade tip that lies along a tip reference line, and wherein a relative angle between the reference line and the tip reference line is in a range between and including 60° and 64°.

The lawnmower of any one or more of the embodiments, further comprising a rake disposed in front of the mower deck, wherein the rake defines a hub and a plurality of projections extending from the hub, and wherein the plurality of projections are arranged in a plurality of rows including at least a first row and a second row.

The lawnmower of any one or more of the embodiments, wherein an agitator assembly is coupled to the mower deck, wherein the agitator assembly comprises blades that extend into the volume, and wherein the blades break apart clumped grass within the volume prior to deposition onto the underlying ground surface.

The lawnmower of any one or more of the embodiments, wherein the mower deck defines a cut zone and a no-cut zone, wherein the no-cut zone extends from the front lip in a rearward direction, and wherein the no-cut zone terminates in a forward-rearward direction within 25% of the nearest part of the cutting implement when the cutting implement extends in the forward-rearward direction.

A mower deck for a lawnmower, the mower deck comprising: a body defining a volume having a first radial length A₁, as measured from a central vertex of a cutting element housed in the mower deck to a front lip of the mower deck, and a second radial length A₂, as measured from the central vertex to a lateral lip of the mower deck, wherein an aspect ratio of the first and second radial lengths [A₁/A₂] is at least 1.05, and wherein a tip distance, as measured between the front lip of the mower deck and a nearest part of a cutting implement to be received in the mower deck when the cutting implement extends in a forward-rearward direction, is at least 1.5 inches.

The mower deck of any one or more of the embodiments, wherein the aspect ratio of the first and second radial lengths [A₁/A₂] is at least 1.1, and wherein the tip distance is at least 3 inches

The mower deck of any one or more of the embodiments, wherein the volume defines a rear airflow pocket.

The mower deck of any one or more of the embodiments, wherein the mower deck is configured to receive a diffuser, wherein the diffuser is removably disposed at a rear end of the mower deck in communication with the volume, and wherein the diffuser disperses airflow generated by a cutting implement to create a diffusion pattern of clippings on an underlying ground surface.

The mower deck of any one or more of the embodiments, further comprising a first wheel rake and a second wheel rake, wherein the first and second wheel rakes are configured to be disposed in front of rear wheels of the lawnmower, and wherein each of the first and second wheel rakes comprises a channel that receives the lateral lip of the mower deck on opposite sides of the mower deck.

The mower deck of any one or more of the embodiments, wherein the mower deck defines a cut zone and a no-cut zone, wherein the no-cut zone extends from the front lip in a rearward direction, and wherein the no-cut zone terminates in a forward-rearward direction within 25% of the nearest part of the cutting implement when the cutting implement extends in the forward-rearward direction.

The mower deck of any one or more of the embodiments, wherein a front half of the mower deck is an elongated-oval in a forward direction, and wherein a rear half of the mower deck is circular.

A method of mowing, the method comprising: activating a bail and a throttle to propel the lawnmower while a cutting implement is driven to rotate within a volume of a mower deck; as the lawnmower moves forward, causing, by a front lip of the mower deck, grass blades to become bent under the front lip to form a no-cut zone within the mower deck; and as a result of a tip distance, as measured between the front lip of the mower deck and a nearest part of the cutting implement when the cutting implement extends in a forward-rearward direction, being at least 1.5 inches, the grass blades entering a cut zone of the cutting implement within 25% of the nearest part of the cutting implement when the cutting implement extends in the forward-rearward direction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A lawnmower comprising:
a mower deck defining a volume;
a driving element configured to drive a cutting implement within the volume;
a plurality of wheels supporting the mower deck; and
a handle extending in a rearward direction from the mower deck,
wherein the mower deck defines a first radial length A₁, as measured from a central vertex of the cutting implement to a front lip of the mower deck, and a second radial length A₂, as measured from the central vertex to a lateral lip of the mower deck,
wherein an aspect ratio of the first and second radial lengths [A₁/A₂] is at least 1.05, and
wherein a tip distance, as measured between the front lip of the mower deck and a nearest part of the cutting implement when the cutting implement extends in a forward-rearward direction, is at least 1.5 inches.

2. The lawnmower of claim 1, wherein the aspect ratio of the first and second radial lengths [A₁/A₂] is at least 1.1, and wherein a lateral tip distance, as measured between the lateral lip of the mower deck and the nearest part of the cutting implement when the cutting implement extends in a lateral direction, is less than 0.5 inches.

3. The lawnmower of claim 1, wherein the lawnmower further comprises a rake disposed in front of one of the plurality of wheels, the rake defining a plurality of projections arranged in front of the wheel and extending towards an underlying ground surface.

4. The lawnmower of claim 3, wherein the rake is spaced apart from a tread of the wheel by a gap of less than 1 inch, and wherein the rake is configured to remove detritus from the tread as the wheel rotates.

5. The lawnmower of claim 3, wherein the rake extends laterally inward past the wheel, laterally outward past the wheel, or both laterally inward past the wheel and laterally outward past the wheel.

6. The lawnmower of claim 1, wherein the lawnmower further comprises a diffuser, wherein the diffuser is removably disposed at a rear end of the mower deck in communication with the volume, and wherein the diffuser disperses airflow generated by the cutting implement to create a diffusion pattern of clippings on an underlying ground surface.

7. The lawnmower of claim 6, wherein the diffuser comprises an agitator configured to at least partially generate the diffusion pattern, and wherein the diffuser pattern is selectable between a plurality of different diffusion patterns.

8. The lawnmower of claim 1, wherein the lawnmower further comprises a trailing conditioner hanging from a rear end of the mower deck, the trailing conditioner comprising a sheet defining a plurality of perforations, and wherein the perforations are configured to receive grass blades such that any grass clumps are pulled apart by force imparted on the received grass blades by movement of the sheet over the underlying ground surface.

9. The lawnmower of claim 1, wherein the lawnmower further comprises a trailing conditioner hanging from a rear end of the mower deck, the trailing conditioner comprising a flexible mass that hangs behind the mower deck and has a major surface that pulls along an underlying ground surface, and wherein the sheet comprises a plurality of perforations.

10. The lawnmower of claim 1, wherein the cutting implement comprises a blade, wherein the blade comprises a cutting surface that extends along a reference line, wherein the blade comprises a blade tip that lies along a tip reference line, and wherein a relative angle between the reference line and the tip reference line is in a range between and including 60° and 68°.

11. The lawnmower of claim 1, wherein an agitator assembly is coupled to the mower deck, wherein the agitator assembly comprises blades that extend into the volume, and wherein the blades break apart clumped grass within the volume prior to deposition onto the underlying ground surface.

12. The lawnmower of claim 1, wherein the mower deck defines a cut zone and a no-cut zone, wherein the no-cut zone extends from the front lip in a rearward direction, and wherein the no-cut zone terminates in a forward-rearward direction within 25% of the nearest part of the cutting implement when the cutting implement extends in the forward-rearward direction.

13. A mower deck for a lawnmower, the mower deck comprising:
a body defining a volume having a first radial length A₁, as measured from a central vertex of a cutting implement housed in the mower deck to a front lip of the mower deck, and a second radial length A₂, as measured from the central vertex to a lateral lip of the mower deck,
wherein an aspect ratio of the first and second radial lengths [A₁/A₂] is at least 1.05, and
wherein a tip distance, as measured between the front lip of the mower deck and a nearest part of a cutting implement to be received in the mower deck when the cutting implement extends in a forward-rearward direction, is at least 1.5 inches.

14. The mower deck of claim 13, wherein the aspect ratio of the first and second radial lengths [A₁/A₂] is at least 1.1, and wherein the tip distance is at least 2 inches.

15. The mower deck of claim 13, wherein the volume defines a rear airflow pocket.

16. The mower deck of claim 13, wherein the mower deck is configured to receive a diffuser, wherein the diffuser is removably disposed at a rear end of the mower deck in communication with the volume, and wherein the diffuser disperses airflow generated by a cutting implement to create a diffusion pattern of clippings on an underlying ground surface.

17. The mower deck of claim 13, further comprising a first wheel rake and a second wheel rake, wherein the first and second wheel rakes are configured to be disposed in front of rear wheels of the lawnmower, and wherein each of the first and second wheel rakes comprises a channel that receives the lateral lip of the mower deck on opposite sides of the mower deck.

18. The mower deck of claim 13, wherein the mower deck defines a cut zone and a no-cut zone, wherein the no-cut zone extends from the front lip in a rearward direction, and wherein the no-cut zone terminates in a forward-rearward direction within 25% of the nearest part of the cutting implement when the cutting implement extends in the forward-rearward direction.

19. The mower deck of claim 13, wherein a front half of the mower deck is an elongated-oval in a forward direction, and wherein a rear half of the mower deck is circular.

20. A method of mowing, the method comprising:
activating a bail and a throttle to propel the lawnmower while a cutting implement is driven to rotate within a volume of a mower deck;
as the lawnmower moves forward, causing, by a front lip of the mower deck, grass blades to become bent under the front lip to form a no-cut zone within the mower deck; and
as a result of a tip distance, as measured between the front lip of the mower deck and a nearest part of the cutting implement when the cutting implement extends in a forward-rearward direction, being at least 1.5 inches, the grass blades entering a cut zone of the cutting implement within 25% of the nearest part of the cutting implement when the cutting implement extends in the forward-rearward direction.
